(19) United States
(12) Patent Application Publication
(10) Pub. No.: US 2026/0094937 A1
(43) Pub. Date: Apr. 2, 2026

(54) SEPARATOR FOR ELECTROCHEMICAL DEVICE AND ELECTROCHEMICAL DEVICE INCLUDING THE SAME

(71) Applicant: LG ENERGY SOLUTION, LTD., Seoul (KR)

(72) Inventors: Jin Young Shin, Daejeon (KR); Kyung Ryun Ka, Daejeon (KR); In Hyouk Sung, Daejeon (KR); Hye Won Kim, Daejeon (KR); So Young Yoon, Daejeon (KR)

(73) Assignee: LG ENERGY SOLUTION, LTD., Seoul (KR)

(21) Appl. No.: 19/344,359

(22) Filed: Sep. 29, 2025

(30) Foreign Application Priority Data
Sep. 30, 2024 (KR) 10-2024-0133067

(51) Int. Cl. H01M 50/451; C09J 127/16; C09J 133/04; H01M 50/417; H01M 50/42; H01M 50/426; H01M 50/434; H01M 50/443; H01M 50/446; H01M 50/457; H01M 50/46; H01M 50/489

(52) U.S. Cl. CPC H01M 50/451; C09J 127/16; C09J 133/04; H01M 50/417; H01M 50/42; H01M 50/426; H01M 50/434; H01M 50/443; H01M 50/446; H01M 50/457; H01M 50/461; H01M 50/489

(57) ABSTRACT

A separator for an electrochemical device of the present disclosure includes: a porous polymer substrate; a coating layer provided on at least one surface of the porous polymer substrate, and including a first acrylic polymer binder, a hybrid polymer binder, and inorganic particles; and an adhesive layer including a second acrylic polymer binder, on the coating layer. The adhesive layer forms a pattern having a predetermined coverage on the coating layer.

### CROSS REFERENCES TO RELATED APPLICATIONS

This application is based on and claims priority from Korean Patent Application No. 10-2024-0133067, filed on Sep. 30, 2024, with the Korean Intellectual Property Office, the disclosure of which is incorporated herein in its entirety by reference.

### TECHNICAL FIELD

The present disclosure relates to a separator for an electrochemical device and the electrochemical device including the same.

### BACKGROUND

An electrochemical device converts chemical energy into electrical energy by using electrochemical reactions. In recent years, lithium secondary batteries, which have a high energy density, a high voltage, and a long cycle life and can be used in various fields, are being used widely.

A lithium secondary battery may include an electrode assembly manufactured by a positive electrode, a negative electrode, and a separator disposed between the positive electrode and the negative electrode, and may be manufactured by disposing the electrode assembly in a case together with an electrolyte.

Meanwhile, the separator of the lithium secondary battery serves to prevent an electrical contact between the positive electrode and the negative electrode while enabling the movement of lithium ions between the electrodes, and then plays an important role in the safety and performance of the battery.

### SUMMARY

The present disclosure provides a separator for an electrochemical device and the electrochemical device including the same, in which a hybrid polymer binder is included in a coating layer and the coverage of an adhesive layer is adjusted so as to obtain a resistance improving effect.

However, the present disclosure are not limited to the above-mentioned features, and other unmentioned features will be clearly understood by those skilled in the art from the following description.

A separator for an electrochemical device provided in one embodiment of the present disclosure includes: a porous polymer substrate; a coating layer provided on at least one surface of the porous polymer substrate, and including a first acrylic polymer binder, a hybrid polymer binder, and inorganic particles; and an adhesive layer including a second acrylic polymer binder, on the coating layer. The adhesive layer forms a pattern having a predetermined coverage on the coating layer.

The thickness of the porous polymer substrate may be about 8 μm to 15 μm. The thickness of the coating layer may be about 1 μm to 3 μm.

The content of the first acrylic polymer binder may be about 1 part by weight to 10 parts by weight relative to 100 parts by weight of the coating layer.

The content of the hybrid polymer binder may be about 1 part by weight to 10 parts by weight relative to 100 parts by weight of the coating layer.

The hybrid polymer binder may include a fluorinated copolymer and an acrylic copolymer.

The fluorinated copolymer may be a copolymer of polyvinylidene fluoride (PVDF) and hexafluoropropylene (HFP).

The content of the hexafluoropropylene (HFP) may be about 5 wt % to 20 wt % relative to 100 wt % of the fluorinated copolymer.

The content of the second acrylic polymer binder may be about 80 parts by weight to 95 parts by weight relative to 100 parts by weight of the adhesive layer.

The adhesive layer forming the pattern on the coating layer may be distributed with a coverage corresponding to greater than about 0% and less than or equal to 30% of the surface area of the coating layer.

The thickness of the adhesive layer may be about 0.2 μm to 1 μm.

The resistance change rate of the separator may be about 20% or less.

The wet adhesive strength of the separator may be about 8 gf/20 mm to 20 gf/20 mm.

The electrochemical device provided in one embodiment of the present disclosure includes the above-described separator for the electrochemical device, which is located between the positive electrode and the negative electrode.

The separator for the electrochemical device according to one embodiment of the present disclosure includes a hybrid polymer binder in the coating layer, and the coverage of the adhesive layer is adjusted, thereby minimizing the resistance change rate.

The electrochemical device according to one embodiment of the present disclosure includes a hybrid polymer binder in the coating layer, and the coverage of the adhesive layer is adjusted. Thus, it is possible to minimize the resistance change rate without reducing the adhesive strength even after electrolyte impregnation.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a schematic view of a separator for an electrochemical device, according to an embodiment of the present disclosure.

FIG. 2 is a SEM image of a separator surface of Example 1, according to an embodiment of the present disclosure.

FIG. 3 is a SEM image of a separator surface of Example 2, according to an embodiment of the present disclosure.

FIG. 4 is a SEM image of a separator surface of Comparative Example 1, according to an embodiment of the present disclosure.

Corresponding reference characters indicate corresponding components throughout the several views of the drawings, but different reference characters may be given as necessary. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

In this specification, when it is said that a certain part “includes” a certain component, this means that the certain part may further include other components rather than excluding other components unless specifically stated to the contrary.

In this specification, “A and/or B” means “A and B, or A or B.”

In this specification, “about,” “approximately,” and “substantially” are used to mean ranges (e.g., ±5%) of numerical values or degrees or approximations thereof, taking into account inherent manufacturing and material tolerances, and are used to prevent infringers from unfairly using the disclosed contents in which precise or absolute figures provided for aiding the understanding of the present disclosure are mentioned.

In this specification, when one component is said to be provided “on” the other component, this does not exclude other components disposed between these, but means that other components may be further disposed unless specifically stated to the contrary.

In this specification, the characteristic of having pores means that the object includes a plurality of pores, and the pores are connected to each other to form a structure that allows gaseous and/or liquid fluid to pass from one side surface to the other side surface of the object.

In this specification, a separator has a porous characteristic including a large number of pores, and serves as a porous ion-conducting barrier that blocks an electrical contact between a negative electrode and a positive electrode in an electrochemical device while allowing ions to pass.

In this specification, “wet state” may mean a state where a separator is at least partially impregnated with an electrolyte, and “dry state” may mean a dry state where a separator is not impregnated with an electrolyte.

In this specification, “durability” may mean that when a binder comes in contact with an electrolyte, properties such as adhesive strength or mechanical strength are exhibited as original properties without swelling or deformation.

Among components of an electrochemical device, a separator may include a polymer substrate having a porous structure located between a positive electrode and a negative electrode. The separator plays a role in preventing an electrical short between the positive electrode and the negative electrode by separating two electrodes from each other while playing a role in allowing electrolyte and ions to pass therethrough. Although the separator itself does not participate in an electrochemical reaction, physical properties such as wettability to the electrolyte, porosity, and thermal shrinkage may affect the performance and safety of the electrochemical device.

Therefore, in order to enhance these physical properties of the separator, various methods have been attempted, in which a coating layer is added to a porous polymer substrate, and various materials are added to the coating layer so as to improve the properties of the coating layer. As an example, in order to improve the mechanical strength of the separator, inorganic substances may be added to the coating layer, or inorganic substances or hydrates for improving the flame retardancy and heat resistance of the polymer substrate may be added to the coating layer.

Within the coating layer, inorganic particles may be linked to other inorganic particles by a polymer binder to form an interstitial volume, and lithium ions may move through the interstitial volume. For example, the coating layer containing the polymer binder, and the inorganic particles plays a role in assisting the movement of lithium ions through the separator while playing a role in preventing or suppressing thermal shrinkage of the separator.

Meanwhile, an acrylic polymer binder is used in this coating layer to improve adhesive strength, durability, and the like, but when this acrylic polymer binder is introduced into the separator coating layer of a lithium secondary battery, the adhesive strength may be reduced due to swelling in the electrolyte. Then, the acrylic polymer binder may act as a resistor itself, causing an increase in battery resistance and a decrease in performance.

In consideration of the problems caused by introduction of this acrylic polymer binder into the separator, the present disclosure provides a separator in which the resistance and adhesive strength can be improved even in a case of electrolyte impregnation.

Hereinafter, one embodiment of the present disclosure will be described with reference to accompanying drawings. The drawings may be exaggerated, omitted, or schematically illustrated to describe or emphasize the contents of one embodiment of the present disclosure.

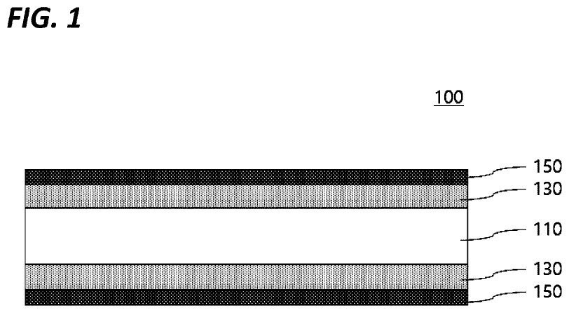

FIG. 1 is a schematic view of a separator for an electrochemical device, according to one embodiment of the present disclosure.

One embodiment of the present disclosure includes a separator 100 for an electrochemical device, which includes: a porous polymer substrate 110; a coating layer 130 provided on at least one surface of the porous polymer substrate, and including a first acrylic polymer binder, a hybrid polymer binder, and inorganic particles; and an adhesive layer 150 including a second acrylic polymer binder, on the coating layer. The adhesive layer forms a pattern on the coating layer.

The separator 100 for the electrochemical device includes the porous polymer substrate 110. As described above, since the separator 100 for the electrochemical device includes the porous polymer substrate 110, it is possible to allow lithium ions to pass while blocking electrical contact, and at the same time, a shutdown function may be implemented at an appropriate temperature. The shutdown function is a function that prevents or suppress thermal runaway, in which when the battery is overheated, the separator blocks its pores, thereby cutting off the current flow. In this function, when the internal temperature of the battery rises above a certain temperature, the separator melts so that its pores are blocked, thereby blocking the contact between the positive electrode and the negative electrode and stopping the current flow.

According to one embodiment of the present disclosure, the porous polymer substrate 110 may be manufactured using a polyolefin-based resin as a base resin. Examples of the polyolefin-based resin may include polyethylene, polypropylene, and polypentene, and at least one type of these may be included. A porous separator manufactured using this polyolefin-based resin as a base resin, e.g., a separator having a large number of pores, may provide a shutdown function at an appropriate temperature.

According to one embodiment of the present disclosure, the weight average molecular weight of the polyolefin-based resin may be about 500,000 to 2,000,000. By adjusting the weight average molecular weight of the polyolefin-based resin within the above-described range, the compression resistance of the separator may be improved. Furthermore, when a mixture of different types of polyolefin-based resins is used or a separator is formed with a multi-layered structure made of different types of polyolefin-based resins, the weight average molecular weight of the polyolefin-based resin may be calculated by adding up the weight average molecular weights according to the respective content ratios of the polyolefin-based resins.

In this specification, the weight average molecular weight (Mw) may be measured by gel permeation chromatography (GPC, PL GPC220, Agilent Technologies), and in one embodiment, the measurement conditions may be set as follows.
Column: PL Olexis (Polymer Laboratories)
Solvent: TCB (Trichlorobenzene)
Flow rate: 1.0 ml/min
Sample concentration: 1.0 mg/ml
Injection volume: 200 μl
Column temperature: 160° C.
Detector: Agilent High Temperature RI detector
Standard: Polystyrene (corrected by a cubic function)

According to one embodiment of the present disclosure, the porous polymer substrate 110 may be manufactured by a wet method in which a polyolefin-based resin may be mixed with a diluent at high temperatures to form a single phase, and phase-separation between the polymer material and the diluent may be induced in the cooling process, and then the diluent may be extracted to form pores and subsequently, stretching and heat-setting may be performed.

According to one embodiment of the present disclosure, the mixing ratio of the diluent, the stretching ratio, the heat-setting temperature, and the like, may be easily controlled by a person skilled in the art so that the average pore size and the maximum pore size of the porous polymer substrate 110 fall within the ranges of the present disclosure.

According to one embodiment of the present disclosure, the thickness of the porous polymer substrate 110 may be about 8 μm to 15 μm. For example, the thickness of the porous polymer substrate 110 may be about 8 μm to 14 μm, 8 μm to 13 μm, 8 μm to 12 μm, 8 μm to 11 μm, or 9 μm to 10 μm, or may be 9 μm in one embodiment. By controlling the thickness of the porous polymer substrate 110 within the above-described range, it is possible to improve the energy density of the battery.

According to one embodiment of the present disclosure, the thickness of the porous polymer substrate 110 may be measured by using a thickness measuring device (Mitutoyo corporation, VL-50S-B) through a contact-type measurement method.

According to one embodiment of the present disclosure, the coating layer 130 is provided on at least one surface of the porous polymer substrate 110. As described above, since the separator 100 for the electrochemical device includes the coating layer 130 provided on at least one surface of the porous polymer substrate 110, the heat resistance of the separator 100 may be improved, the mechanical properties may be improved, and the separator may be prevented or suppressed from shrinking at high temperatures and causing an electrical short-circuit in the electrode.

According to one embodiment of the present disclosure, the coating layer 130 includes a first acrylic polymer binder, a hybrid polymer binder, and inorganic particles. As described above, since the coating layer 130 includes the first acrylic polymer binder, the hybrid polymer binder, and the inorganic particles, the heat resistance of the separator 100 is improved, and the mechanical properties are improved, so that the separator 100 is prevented or suppressed from shrinking at high temperatures and causing an electrical short-circuit in the electrode. Then, pores may be formed inside the coating layer and swelling may be suppressed even after electrolyte impregnation, thereby improving the resistance of the secondary battery.

According to one embodiment of the present disclosure, the coating layer 130 may be formed by the inorganic particles being bound by the first acrylic polymer binder and the hybrid polymer binder and accumulated within the layer. The pores within the coating layer may be derived from the interstitial volumes that are empty spaces between the inorganic particles.

According to one embodiment of the present disclosure, the coating layer 130 may include a plurality of pores. For example, the coating layer 130 may be a porous coating layer. The coating layer 130 may be a porous coating layer including a plurality of pores therein. As described above, since the coating layer 130 includes the plurality of pores, lithium ions are allowed to pass and then current is allowed to flow while a negative electrode and a positive electrode are physically blocked from each other.

According to one embodiment of the present disclosure, the coating layer 130 may be provided on both surfaces of the porous polymer substrate 110. As described above, since the separator 100 for the electrochemical device includes the coating layers 130 provided on both surfaces of the porous polymer substrate 110, the heat resistance of the separator 100 may be improved, and the resistance may be improved. Meanwhile, the present disclosure is not limited thereto, and the coating layer 130 may be provided on a single surface of the porous polymer substrate 110.

According to one embodiment of the present disclosure, the thickness of the coating layer 130 may be about 1 μm to 3 μm. For example, the thickness of the coating layer 130 may be about 1 μm to 2 μm. By controlling the thickness of the coating layer 130 within the above-described range, it is possible to improve the heat resistance characteristics and resistance characteristics of the separator, and furthermore, the battery resistance and cycle performance may also be maintained at an appropriate level.

In one embodiment of the present disclosure, the thicknesses of the coating layer 130, and the like, may be measured by employing a contact-type thickness measuring device. As for the contact-type thickness measuring device, for example, VL-50S-B of Mitutoyo corporation may be used.

According to one embodiment of the present disclosure, the inorganic particles usable for the coating layer 130 are not particularly limited as long as they are electrochemically stable. For example, the inorganic particles that can be used in one embodiment of the present disclosure are not particularly limited as long as no oxidation and/or reduction reaction occurs in the operating voltage range (e.g., 0 V to 5 V based on Li/Li⁺) in the application to an electrochemical device.

According to one embodiment of the present disclosure, examples of the inorganic particles may include boehmite, BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, Al₂O₃, SiC, Al(OH)₃, TiO₂, aluminum peroxide, zinc tin hydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅), and among these, one or two or more may be included.

According to one embodiment of the present disclosure, the inorganic particles may be boehmite. As described above, by selecting boehmite as the inorganic particles, a uniform coating layer may be formed, thereby improving the heat resistance of the separator.

According to one embodiment of the present disclosure, the average particle diameter (D50) of the inorganic particles is not particularly limited, but may be adjusted to about 0.1 μm to 1 μm in order to form the coating layer 130 with a uniform thickness and to obtain an appropriate porosity. For example, the average particle diameter (D50) of the inorganic particles may be about 0.1 μm to 0.9 μm, 0.1 μm to 0.8 μm, 0.1 μm to 0.7 μm, 0.2 μm to 0.6 μm, 0.2 μm to 0.5 μm, 0.2 μm to 0.4 μm or 0.2 μm to 0.3μ m. Within the above-described range of the average particle diameter (D50), the dispersibility of the inorganic particles may be appropriately maintained in a slurry prepared for producing the coating layer, and the coating density and porosity may also be maintained at appropriate values, thereby improving ionic conductivity. Also, within the above-described range of the average particle diameter (D50), the thickness of the coating layer 130 to be formed may be stably maintained, and the uniformity may be improved.

In this specification, the “D50 particle diameter” refers to a particle diameter at the point of 50% in the cumulative distribution of the number of particles based on the particle diameter. The particle diameter may be measured by using a laser diffraction method. Specifically, measurement target powder is dispersed in a dispersion medium, and then is introduced into a commercially available laser diffraction particle size measurement device (e.g., Microtrac S3500). Then, when the particles pass through laser beam, the particle size distribution is calculated by measuring the difference in the diffraction pattern according to the particle size. The D50 particle diameter may be measured by calculating the particle diameter at the point of 50% in the cumulative distribution of the number of particles based on the particle diameter, in the measuring device.

According to one embodiment of the present disclosure, the content of the inorganic particles may be about 90 parts by weight or more and less than 100 parts by weight with respect to 100 parts by weight of the coating layer 130. For example, the content of the inorganic particles may be about 91 parts by weight to 99 parts by weight, 92 parts by weight to 98 parts by weight, 93 parts by weight to 97 parts by weight, or 93 parts by weight to 95 parts by weight relative to 100 parts by weight of the coating layer 130. By controlling the content of the inorganic particles included in the coating layer 130 within the above-described range, the heat resistance of the separator may be improved, thereby ensuring the safety of the battery.

According to one embodiment of the present disclosure, the content of the first acrylic polymer binder may be about 1 part by weight to 10 parts by weight relative to 100 parts by weight of the coating layer. For example, the content of the first acrylic polymer binder may be about 1 part by weight to 9 parts by weight, 1 part by weight to 8 parts by weight, 1 part by weight to 7 parts by weight, 1 part by weight to 6 parts by weight, 1 part by weight to 5 parts by weight, 1 part by weight to 4 parts by weight, or 1 part by weight to 3 parts by weight relative to 100 parts by weight of the coating layer. By controlling the content of the first acrylic polymer binder within the above-described range, it is possible to improve the binding force with the inorganic particles and to improve the binding force between the separator and the electrode, thereby improving battery performance.

According to one embodiment of the present disclosure, the first acrylic polymer binder may be an acrylic binder. For example, the acrylic binder is a polymer containing a carboxylic acid ester as a repeating unit, and may be (meth)acrylic acid ester or an acrylic-styrene copolymer in one embodiment.

According to one embodiment of the present disclosure, the (meth)acrylic acid ester may be, for example, methyl (meth)acrylate, ethyl (meth)acrylate, n-propyl (meth)acrylate, i-propyl (meth)acrylate, n-butyl (meth)acrylate, i-butyl (meth)acrylate, n-amyl (meth)acrylate, i-amyl (meth)acrylate, hexyl (meth)acrylate, cyclohexyl (meth)acrylate, 2-ethylhexyl (meth)acrylate, n-octyl (meth)acrylate, nonyl (meth)acrylate, decyl (meth)acrylate, hydroxymethyl (meth)acrylate, hydroxyethyl (meth)acrylate, ethyleneglycol (meth)acrylate, ethyleneglycol di(meth)acrylate, propyleneglycol di(meth)acrylate, trimethylolpropane tri(meth)acrylate, pentaerythritol tetra(meth)acrylate, dipentaerythritol hexa(meth)acrylate, allyl (meth)acrylate, or ethylene di(meth)acrylate, or may be at least one type selected from these. Among these, the (meth)acrylic acid ester may be at least one type selected from methyl (meth)acrylate, ethyl (meth)acrylate and 2-ethylhexyl (meth)acrylate, or may be methyl (meth)acrylate.

According to one embodiment of the present disclosure, the acrylic-styrene copolymer may include an acrylic binder, and the acrylic binder may be a polyacrylate-based binder. For example, the binder may be at least one type selected from styrene-butyl acrylate, styrene-butadiene rubber, nitrile-butadiene rubber, acrylonitrile-butadiene rubber, acrylonitrile-butadiene-styrene rubber, and acrylate-based polymer, and specifically, may be a copolymer containing acrylate.

According to one embodiment of the present disclosure, the average particle diameter (D50) of the first acrylic polymer binder is not particularly limited, but may fall within a range of about 0.1 μm to 1 μm in order to form the coating layer 130 with a uniform thickness and to obtain an appropriate porosity. For example, the average particle diameter (D50) of the first acrylic polymer binder may be about 0.1 μm to 0.8 μm, 0.1 μm to 0.6 μm, 0.1 μm to 0.4 μm, or 0.1 μm to 0.2 μm. By controlling the average particle diameter (D50) of the first acrylic polymer binder within the above-described range, the dispersibility may be improved in a slurry prepared for producing the coating layer 130, and the thickness of the coating layer 130 to be formed may be reduced.

According to one embodiment of the present disclosure, the content of the hybrid polymer binder may be about 1 part by weight to 10 parts by weight relative to 100 parts by weight of the coating layer 130. For example, the content of the hybrid polymer binder may be about 1 part by weight to 9 parts by weight, 1 part by weight to 8 parts by weight, 1 part by weight to 7 parts by weight, 1 part by weight to 6 parts by weight, 1 part by weight to 5 parts by weight, 1 part by weight to 4 parts by weight, or 1 part by weight to 3 parts by weight, relative to 100 parts by weight of the coating layer 130. By controlling the content of the hybrid polymer binder within the above-described range, it is possible to reduce the resistance change rate while maintaining the adhesive strength even after electrolyte impregnation.

According to one embodiment of the present disclosure, the hybrid polymer binder may include a fluorinated copolymer and an acrylic copolymer. For example, the hybrid polymer binder may be an aqueous binder including a fluorinated copolymer and an acrylic copolymer. As described above, since the hybrid polymer binder includes the fluorinated copolymer and the acrylic copolymer, swelling may be suppressed after electrolyte impregnation, thereby suppressing an increase in resistance of the separator 100.

According to one embodiment of the present disclosure, the fluorinated copolymer may be a copolymer of polyvinylidene fluoride (PVDF) and hexafluoropropylene (HFP). For example, the copolymer of polyvinylidene fluoride (PVDF) and hexafluoropropylene (HFP) may improve the flexibility and processability of HFP while maintaining the strength and chemical resistance of PVDF. Also, in the copolymer of polyvinylidene fluoride (PVDF) and hexafluoropropylene (HFP), although the PVDF has various crystal forms, when the HFP is included in the copolymer, the regular chain arrangement of PVDF is disrupted due to the irregular structure of HFP, so that crystallinity is reduced and amorphousness is increased. Thus, such a copolymer may be more flexible. As described above, it is possible to control the chemical resistance and flexibility by selecting a copolymer of polyvinylidene fluoride (PVDF) and hexafluoropropylene (HFP) as the fluorinated copolymer.

According to one embodiment of the present disclosure, the content of the hexafluoropropylene (HFP) may be about 5 wt % to 20 wt % relative to 100 wt % of the fluorinated copolymer. When the above-described range is exceeded, excessive swelling may occur in the electrolyte, resulting in the degradation of the resistance change rate.

In one embodiment of the present disclosure, the adhesive layer 150 containing a second acrylic polymer binder is formed on the coating layer 130. As described above, since the adhesive layer 150 containing the second acrylic polymer binder is formed on the coating layer 130, the adhesive strength may be maintained even after electrolyte impregnation.

According to one embodiment of the present disclosure, the content of the second acrylic polymer binder may be about 80 parts by weight to 95 parts by weight relative to 100 parts by weight of the adhesive layer 150. For example, the content of the second acrylic polymer binder may be about 82 parts by weight to 95 parts by weight, 84 parts by weight to 95 parts by weight, 85 parts by weight to 95 parts by weight, 86 parts by weight to 94 parts by weight, 87 parts by weight to 93 parts by weight, 88 parts by weight to 92 parts by weight, or 89 parts by weight to 91 parts by weight relative to 100 parts by weight of the adhesive layer 150. By controlling the content of the second acrylic polymer binder within the above-described range, it is possible to maintain the adhesive strength even after electrolyte impregnation.

In one embodiment of the present disclosure, the adhesive layer 150 forms a pattern on the coating layer 130. As described above, since the adhesive layer 150 forms a pattern on the coating layer 130, it is possible to minimize the resistance change rate while maintaining an adhesive strength at or above a certain level.

According to one embodiment of the present disclosure, the pattern-forming adhesive layer 150 may be distributed with a coverage corresponding to greater than about 0% and less than or equal to 30% of the surface area of the coating layer 130. For example, the coverage of the pattern-forming adhesive layer 150 may be about 5% to 30%, 10% to 30%, or 15% to 30%. Within the above-described range of the coverage, the adhesive strength may be improved and the resistance change rate may be reduced, thereby improving the battery performance.

According to one embodiment of the present disclosure, the thickness of the adhesive layer 150 may be about 0.2 μm to 1 μm. For example, the thickness of the adhesive layer may be about 0.2 μm to 0.9 μm, 0.2 μm to 0.8 μm, 0.2 μm to 0.7 μm, 0.2 μm to 0.6 μm, 0.3 μm to 0.6 μm, or 0.4 μm to 0.5 μm. Within the above-described range of the thickness, the adhesive strength may be improved and the resistance change rate may be reduced, thereby improving the battery performance.

According to one embodiment of the present disclosure, the resistance change rate of the separator 100 may be about 20% or less. For example, the resistance change rate of the separator 100 may be about 1% to 20%, 1% to 19%, 1% to 18%, 5% to 18% or 10% to 18%. By controlling the resistance change rate within the above-described range, it is possible to improve the battery performance.

According to one embodiment of the present disclosure, the wet adhesive strength of the separator 100 may be about 8 gf/20 mm to 20 gf/20 mm. For example, the wet adhesive strength of the separator may be about 8 gf/20 mm to 16 gf/20 mm. Within the above-described range of the wet adhesive strength, the battery performance may be improved, and at the same time, the resistance value may be maintained at an appropriate level.

The manufacturing method of the separator for the electrochemical device according to one embodiment of the present disclosure includes the steps of: providing the porous polymer substrate 110; preparing a coating layer slurry including a first acrylic polymer binder, a hybrid polymer binder, and inorganic particles; forming the coating layer 130 by applying the coating layer slurry including the first acrylic polymer binder, the hybrid polymer binder, and the inorganic particles to at least one surface of the porous polymer substrate 110, and drying the slurry; preparing an adhesive layer slurry including a second acrylic polymer binder; and forming the adhesive layer 150 by applying the adhesive layer slurry including the second acrylic polymer binder to the coating layer 130, and drying the slurry. In the manufacturing method of the separator for the electrochemical device, more detailed contents of processing in each step will be described in more detail in the following description of Examples. Meanwhile, the order of the above steps is not specifically determined, and may be appropriately rearranged as needed. For example, the step of preparing the coating layer slurry may be performed before the step of preparing the porous polymer substrate 110, or the step of preparing the adhesive layer slurry may be performed before the step of preparing the coating layer slurry.

According to one embodiment of the present disclosure, the solid content of the adhesive layer slurry may be about 1% to 10%. For example, the solid content of the adhesive layer slurry may be about 1% to 9%, 1% to 8%, 1% to 7%, 1% to 6%, 1% to 5%, 1% to 4%, or 2% to 4%. Within the above-described range of the solid content, the coverage of the adhesive layer 150 is appropriately maintained so that an increase in resistance may be suppressed, and the adhesive strength may be improved.

The cylindrical lithium secondary battery, which is an electrochemical device according to one embodiment of the present disclosure, includes a positive electrode; a negative electrode; and the above-described separator for the electrochemical device, which is located between the positive electrode and the negative electrode. The cylindrical lithium secondary battery may be manufactured by inserting an electrode assembly including the positive electrode, the negative electrode, and the separator, into a battery case, and sealing the battery case. Before the battery case is sealed, an electrolyte may be injected to impregnate the electrode assembly with the electrolyte. In the present embodiment, the cylindrical lithium secondary battery is exemplified as the electrochemical device, but the present disclosure is not limited thereto. Then, the electrochemical device may be another type of secondary battery, for example, a cylindrical, prismatic, coin-shaped, or pouch-shaped lithium secondary battery. In the electrochemical device according to one embodiment of the present disclosure, the contents overlapping with the description for the separator for the electrochemical device will be omitted.

The cylindrical lithium secondary battery, which is the electrochemical device according to one embodiment of the present disclosure, includes the hybrid polymer binder in the coating layer of the separator, and the coverage of the adhesive layer is adjusted so that it is possible to improve the adhesive strength and resistance even after the electrolyte impregnation.

In one embodiment of the present disclosure, the electrochemical device is a device that converts chemical energy into electrical energy through an electrochemical reaction, and has a concept that encompasses a primary battery and a secondary battery. In this specification, the secondary battery is chargeable and dischargeable, and refers to a lithium secondary battery, a nickel-cadmium battery, a nickel-hydrogen battery, and the like. The lithium secondary battery uses lithium ions as an ion conductor. Examples thereof may include a non-aqueous electrolyte secondary battery including a liquid electrolyte, a solid-state battery including a solid electrolyte, a lithium polymer battery including a gel polymer electrolyte, and a lithium metal battery using a lithium metal as a negative electrode, but are not limited to these.

According to one embodiment of the present disclosure, the positive electrode includes: a positive electrode current collector; and a positive electrode active material layer including a positive electrode active material, a conductive material, and a binder resin, on at least one surface of the current collector. The positive electrode active material may include one type or a mixture of two or more types among layered compounds such as lithium manganese composite oxide (LiMn₂O₄, LiMnO₂, etc.), lithium cobalt oxide (LiCoO₂), and lithium nickel oxide (LiNiO₂) or compounds substituted with one or more transition metals; lithium manganese oxide such as chemical formulas Li₁₊ₓMn₂₋ₓO₄ (where x is 0 to 0.33), LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇; Ni site-type lithium nickel oxide represented by a chemical formula LiNi₁₋ₓMₓO₂ (where M=Co, Mn, Al, Cu, Fe, Mg, B or Ga, and x=0.01 to 0.3); lithium manganese composite oxide represented by a chemical formula LiMn₁₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); LiMn₂O₄ in which a part of Li in the chemical formula is substituted with an alkaline earth metal ion; a disulfide compound; and Fe₂(MoO₄)₃.

According to one embodiment of the present disclosure, the negative electrode includes: a negative electrode current collector; and a negative electrode active material layer including a negative electrode active material, a conductive material, and a binder resin, on at least one surface of the current collector. The anode may include, as for the negative electrode active material, one type or a mixture of two or more types selected from lithium metal oxides; carbon such as non-graphitizable carbon, or graphite-based carbon; metal composite oxides such as LiₓFe₂O₃ (0≤x≤1), LiₓWO₂ (0≤x≤1), and SnₓMe₁₋ₓMe′_{y}O_{z} (Me: Mn, Fe, Pb, Ge; Me′: Al, B, P, Si, elements of groups 1, 2, and 3 of the periodic table, halogen; 0<x≤1; 1≤y≤3; 1<z≤8); lithium metal; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxide.

According to one embodiment of the present disclosure, the conductive material may be any one selected from, for example, graphite, carbon black, carbon fiber or metal fiber, metal powder, conductive whiskers, conductive metal oxide, activated carbon and polyphenylene derivatives, or a mixture of two or more types of conductive materials of these. For example, the conductive material may be one type selected from natural graphite, artificial graphite, super-p, acetylene black, Ketjen black, channel black, furnace black, lamp black, thermal black, Denka black, aluminum powder, nickel powder, zinc oxide, potassium titanate and titanium oxide, or a mixture of two or more types of conductive materials of these.

According to one embodiment of the present disclosure, the current collector is not particularly limited as long as it has high conductivity without causing chemical changes in the corresponding battery. For example, stainless steel, copper, aluminum, nickel, titanium, calcined carbon, or aluminum or stainless steel whose surface is treated with carbon, nickel, titanium, silver, and the like, may be used as for the current collector.

According to one embodiment of the present disclosure, as for the binder resin, a polymer commonly used for electrodes in the art may be used. Non-limiting examples of this binder resin may include polyvinylidene fluoride-co-hexafluoropropylene, polyvinylidene fluoride-cotrichloroethylene, polymethylmethacrylate, polyetylexyl acrylate, polybutyl acrylate, polyacrylonitrile, polyvinylpyrrolidone, polyvinyl acetate, polyethylene-co-vinyl acetate, polyethylene oxide, polyarylate, cellulose acetate, cellulose acetate butyrate, cellulose acetate propionate, cyanoethylpullulan, cyanoethyl polyvinyl alcohol, cyanoethyl cellulose, cyanoethyl sucrose, pullulan and carboxyl methyl cellulose, and are not limited to these.

According to one embodiment of the present disclosure, a positive electrode slurry for producing the positive electrode active material layer may contain a dispersant. The dispersant may be a pyrrolidone-based compound, and specifically, may be N-methylpyrrolidone (ADC-01, LG chemical).

According to one embodiment of the present disclosure, the electrochemical device may further include an electrolyte, and the electrolyte includes a salt having a structure such as A⁺B⁻, which may be dissolved or dissociated in an organic solvent, but the present disclosure is not limited thereto. A⁺ may include alkali metal cations such as Li⁺, Na⁺, and K⁺ or ions composed of combinations thereof. Also, B⁺ may include anions such as PF₆⁺, BF₄⁺, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻ or ions composed of combinations thereof. The organic solvent includes propylene carbonate (PC), ethylene carbonate (EC), diethylcarbonate (DEC), dimethylcarbonate (DMC), dipropylcarbonate (DPC), dimethylsulfoxide, acetonitrile, dimethoxyethane, diethoxyethane, tetrahydrofuran, N-methyl-2-pyrrolidone (NMP), ethyl methyl carbonate (EMC), gamma butyrolactone or a mixture thereof.

According to one embodiment of the present disclosure, a battery module including a battery including the electrochemical device as a unit cell, a battery pack including the battery module, and a device including the battery pack as a power source may be provided. Specific examples of the device may include: a power tool powered and driven by an electric motor; electric cars including an electric vehicle (EV), a hybrid electric vehicle (HEV), a plug-in hybrid electric vehicle (PHEV), and the like; electric two-wheeled vehicles including an electric bicycle (E-bike), and an electric scooter (E-scooter); an electric golf cart; and a power storage system, but are not limited thereto.

Hereinafter, the present disclosure will be described in detail with reference to examples. However, Examples according to the present disclosure may be modified in various different forms, and the scope of the present disclosure is not construed as being limited to Examples described below. Examples of the present specification are provided to more completely illustrate the present disclosure, to those having average knowledge in the art.

### Example 1

### Manufacturing of Porous Polymer Substrate

A porous polymer substrate was manufactured by extruding polyethylene resin (weight average molecular weight: 1,500,000) through a wet method (the total thickness: about 9 μm).

### Formation of Coating Layer

Boehmite (Nabaltec, Act200SM) powder having a D50 particle diameter of 300 nm was prepared as inorganic particles. A hybrid polymer binder (LBG4330LX, Arkema, D50: 300 nm, a copolymer obtained through copolymerization of PVDF and HFP at a molar ratio of 95:5 and a copolymer of ethyl acrylate and methyl methacrylate (Tg 20° C.) were mixed at a weight ratio of 7:3), a first acrylic polymer binder (CSB-130, Toyochem, D50: 150 nm, Tg −30° C.), a PAA-based dispersant (CK-702, Dow chemical) and a silicone-based surfactant (BYK-348, BYK) were prepared.

The prepared inorganic particles, the hybrid polymer binder, the first acrylic polymer binder, the dispersant and the surfactant were added to water at a weight ratio of 94:2:2:1.4:0.6, and then were dispersed to prepare a slurry for an aqueous coating layer (solid content: 35%).

The aqueous coating layer slurry was applied to both surfaces of the porous polymer substrate by a bar-coating method using a doctor blade, and was dried in wind at 50° C. by using a heat gun so that each coating layer was formed with a thickness of 1.5 μm.

### Formation of Adhesive Layer

A second acrylic polymer binder (BM2510M, Kuraray) and a silicone-based surfactant (BYK-348, BYK) were added to water at a weight ratio of 90:10, and then were dispersed to prepare a slurry for an aqueous adhesive layer (solid content: 2%).

The aqueous adhesive layer slurry was applied to both surfaces of the prepared coating layer by a bar-coating method using a doctor blade, and was dried in wind at 50° C. by using a heat gun so that each adhesive layer was formed with a thickness of 0.5 μm. Here, the coverage of the adhesive layer was 15%.

### Example 2

A separator was prepared in the same manner as in Example 1 except that the solid content of the adhesive layer slurry in Example 1 was 4%, and the corresponding coverage of the adhesive layer was 30%.

### Example 3

A separator was prepared in the same manner as in Example 1 except that in Example 2, the molar ratio of PVDF and HFP was 85:15 (LP22804, LG chemical) in the PVDF-HFP copolymer included in the hybrid polymer binder.

### Example 4

A separator was prepared in the same manner as in Example 1 except that in Example 2, the molar ratio of PVDF and HFP was 80:20 (LP228011, LG chemical) in the PVDF-HFP copolymer included in the hybrid polymer binder.

### Comparative Example 1

A separator was prepared in the same manner as in Example 1 except that the solid content of the adhesive layer slurry in Example 1 was 5%, and the corresponding coverage of the adhesive layer was 50%.

### Comparative Example 2

### Manufacturing of Porous Polymer Substrate

A porous polymer substrate was manufactured by extruding polyethylene resin (weight average molecular weight: 1,500,000) through a wet method (the total thickness: about 9 μm).

### Formation of Coating Layer

Boehmite (Nabaltec, Act200SM) powder having a D50 particle diameter of 300 nm was prepared as inorganic particles. A polyvinylidene fluoride (PVDF) polymer binder (solef21510, Solvay), a chlorotrifluoroethylene (CTFE) polymer binder (solef32008, Solvay) and a PAA-based dispersant (CYR-301, Mitsubishi Chem) were prepared. Comparative Example 2 is different from Examples/Comparative Example in that the hybrid polymer binder has a combination of PVDF+CFFE instead of a combination of PVDF+HFP.

The prepared inorganic particles, the PVDF polymer binder, the CTFE polymer binder, and the PAA-based dispersant were added to acetone at a weight ratio of 81:12:5:2, and then were dispersed to prepare a slurry for an oil-based coating layer (solid content: 18%).

Both surfaces of the porous polymer substrate were dip-coated with the slurry for the oil-based coating layer, and then were dried so that each coating layer was formed with a thickness of 1.5 μm.

### Formation of Adhesive Layer

A second acrylic polymer binder (BM2510M, Zeon) and a silicone-based surfactant (BYK-348, BYK) were added to water at a weight ratio of 90:10, and then were dispersed to prepare a slurry for an aqueous adhesive layer (solid content: 4%).

The aqueous adhesive layer slurry was applied to both surfaces of the prepared coating layer by a bar-coating method using a doctor blade, and was dried in wind at 50° C. by using a heat gun so that each adhesive layer was formed with a thickness of 0.5 μm. Here, the coverage of the adhesive layer was 30%.

### Comparative Example 3

A separator was prepared in the same manner as in Example 2 except that the hybrid polymer binder in Example 2 was not used, and an acrylamide-based binder (SBS-04, Kureha) was used at a weight ratio of 2.

### Comparative Example 4

A separator was prepared in the same manner as in Example 1 except that in Example 1, the solid content of the slurry for the adhesive layer was 4%, and a hybrid polymer binder (LBG4330LX, Arkema, D50: 300 nm, a copolymer obtained through copolymerization of PVDF and HFP at a molar ratio of 95:5 and a copolymer of ethyl acrylate and methyl methacrylate (Tg 20° C.) were mixed at a weight ratio of 7:3) was employed as the binder used for the adhesive layer.

### <Manufacturing of Electrochemical Device>

An electrochemical device was manufactured by using a separator for an electrochemical device in each of Examples and Comparative Examples.

### 1) Manufacturing of Positive Electrode

A positive electrode active material (LiNi_{0.8}Mn_{0.1}Co_{0.1}O₂), a conductive material (carbon black), a dispersant (N-methylpyrrolidone, ADC-01, LG Chemical) and a binder resin (a mixture of PVDF-HFP and PVDF) were mixed with water at a weight ratio of 97.5:0.7:0.14:1.66 to prepare a slurry for a positive electrode active material layer in which the concentration of the remaining components excluding water was 50 wt %. Next, the slurry was applied to the surface of an aluminum thin film (thickness of 10 μm) and was dried to manufacture a positive electrode having a positive electrode active material layer (thickness of 120 μm).

### 2) Manufacturing of Negative Electrode

Graphite (a blend of natural graphite and artificial graphite), a conductive material (carbon black), a dispersant (Polyvinylpyrrolidone, Junsei, Japan) and a binder resin (a mixture of PVDF-HFP and PVDF) were mixed with water at a weight ratio of 97.5:0.7:0.14:1.66 to prepare a slurry for a negative electrode active material layer in which the concentration of the remaining components excluding water was 50 wt %. Next, the slurry was applied to the surface of a copper thin film (thickness of 10 μm) and was dried to manufacture a negative electrode having a negative electrode active material layer (thickness of 120 μm).

### Experimental Example

### Separator Coverage Analysis

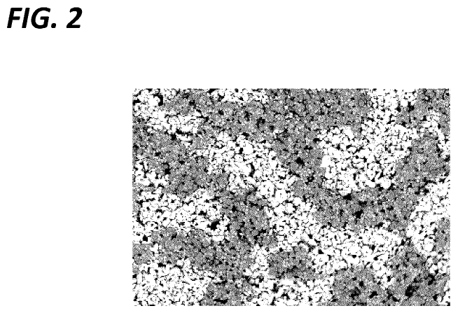

The separator surfaces of Examples 1 and 2 and Comparative Example 1 were measured by a scanning electron microscope (SEM) and are illustrated in FIGS. 2 to 4.

By using an image analysis tool, the % of the coverage area of the adhesive layer was analyzed through a difference in components between the inorganic material and the binder, and is noted in Table 1 below.

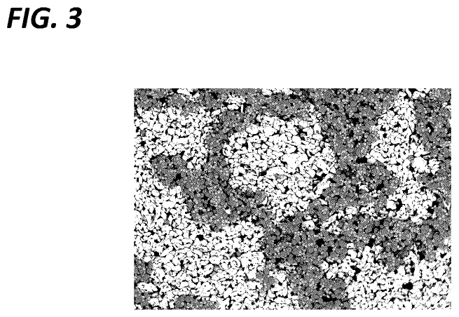

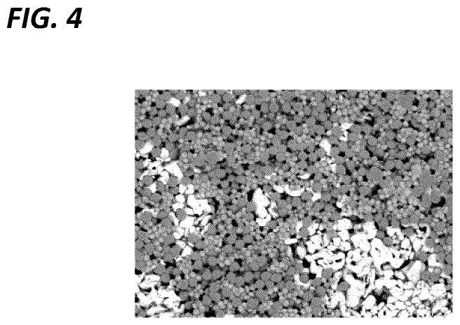

In the SEM measured surface image, the dark-shaded portion indicates an adhesive layer and the light-shaded portion indicates a coating layer. The adhesive layer coverages in Examples 1 and 2, which are illustrated in FIGS. 2 and 3, are 15% and 30%, respectively, and the adhesive layer coverage in Comparative Example 1, which is illustrated in FIG. 4, is 50%.

### Air Permeability Measurement of Separator

For Examples and Comparative Examples, the air permeability (air permeation time, Gurley) was measured by a method of ASTM D726-94. The Gurley used herein refers to a resistance to air flow, and is measured by a Gurley densometer. The air permeability value described herein represents the air permeation time, which is the time (sec) required for 100 cc of air to pass through a cross-section of 1 in² of a separator under a pressure of 12.2 inH₂O. The measured air permeability is noted in Table 1 below.

### Wet Adhesive Strength Measurement of Separator

The separator of Examples and Comparative Examples and the positive electrode were stacked, were impregnated with 1.0 g of an electrolyte (ethylene carbonate: ethyl methyl carbonate=3:7, a volume ratio, 1 M of LiPF₆), and were left at room temperature for 24 hours. Then, a test piece was prepared through lamination using hot pressing. Here, pressurization was performed for 5 min at 70° C. at 5 kgf. The size of the test piece was 2 cm×6 cm.

Then, by using a tensile tester (UTM equipment), the test piece was peeled at an angle of 90° and the wet adhesive strength was measured and is noted in Table 1 below.

### Resistance Change Rate Measurement

The separator in Examples and Comparative Examples was prepared with a dimeter of 19 pi (about 4826 mm), and a 2016 coin cell was manufactured by incorporating the separator and the electrolyte. Here, the electrolyte composition contained 1 M of LiPF₆, and the injected electrolyte included a mixture of ethylene carbonate and ethyl methyl carbonate at a volume ratio of 3:7, and 2 wt % of vinylene carbonate (VC) as an additive. Here, after wetting for 3 hours, the resistance was measured by EIS (Electrochemical Impedance Spectroscopy).

After that, the coin cell was stored in an oven at 70° C. for 12 hours, and then the resistance was re-measured by EIS and the change rate was calculated and is noted in Table 1 below.

### Initial Resistance Measurement of Electrochemical Device

The electrochemical device in Examples and Comparative Examples was charged and discharged three times at 25° C. under a 0.33 C-rate condition, and then the resistance was evaluated on the basis of the resistance value determined when a current was applied at SOC 50 at a C-rate of 2.5 for 10 sec. Measurement results are noted in Table 1 below.

### Measurement of Initial Capacity and Capacity Loss Rate of Electrochemical Device

The electrochemical device in Examples and Comparative Examples was charged at 25° C. in CC-CV mode at 1 C until 4.2 V, and then was discharged at 1 C constant current until 2.5 V. This was set as one cycle. After 100 cycles of charging/discharging were performed, the initial capacity and the capacity loss rate were measured and the life characteristics were evaluated. The measurement results after 500 cycles are noted in Table 1 below.

TABLE 1

| | | | | | | Comp. | Comp. | Comp. | Comp. |
|---|---|---|---|---|---|---|---|---|---|
| | | Exam. 1 | Exam. 2 | Exam. 3 | Exam. 4 | Exam. 1 | Exam. 2 | Exam. 3 | Exam. 4 |
| Coating | Type | acrylic + | acrylic + | acrylic + | acrylic + | acrylic + | PVDF- | acrylamide- | acrylic + |
| layer | | PVDF- | PVDF- | PVDF- | PVDF- | PVDF- | CTFE | based | PVDF- |
| binder | | HFP | HFP | HFP | HFP | HFP | | | HFP |
| | HFP | 5 | 5 | 15 | 20 | 5 | — | — | 5 |
| | content | | | | | | | | |
| | (%) in | | | | | | | | |
| | PVDF- | | | | | | | | |
| | HFP | | | | | | | | |

| | | | | | | | | |
|---|---|---|---|---|---|---|---|---|
| Adhesive layer | acrylic | acrylic | acrylic | acrylic | acrylic | acrylic | acrylic | acrylic + |
| binder | | | | | | | | PVDF-HFP |
| Coverage (%) of | 15 | 30 | 30 | 30 | 50 | 30 | 30 | 30 |
| adhesive layer | | | | | | | | |
| Separator | 13.0 | 13.0 | 13.0 | 12.9 | 13.0 | 13.0 | 12.9 | 13.0 |
| thickness (μm) | | | | | | | | |
| Separator air | 81 | 85 | 86 | 88 | 98 | 120 | 76 | 87 |
| permeability | | | | | | | | |
| (s/100 cc) | | | | | | | | |
| Wet adhesive | 8 | 15 | 16 | 15 | 23 | 15 | 15 | 8 |
| strength (gf/20 | | | | | | | | |
| mm) | | | | | | | | |
| Resistance change | 10 | 12 | 15 | 18 | 30 | 27.8 | 25 | 28 |
| rate (%) | | | | | | | | |
| Battery initial | 40.1 | 40.1 | 39.8 | 39.5 | 39.1 | 39.3 | 39.4 | 39.2 |
| capacity (mAh) | | | | | | | | |
| Battery initial | 1.21 | 1.21 | 1.25 | 1.30 | 1.30 | 1.26 | 1.31 | 1.27 |
| resistance (mohm) | | | | | | | | |
| Capacity loss rate | 2.7 | 2.7 | 4.3 | 7.0 | 7.0 | 5.0 | 7.8 | 6.2 |
| (%) after 500 | | | | | | | | |
| cycles | | | | | | | | |

According to Table 1, the separator and the electrochemical device according to Examples 1 to 4 include the hybrid polymer binder in the coating layer, and the coverage of the adhesive layer formed on the coating layer is adjusted so that it is possible to maintain the adhesive strength while suppressing swelling even in a case of electrolyte impregnation, thereby reducing the resistance change rate. For example, it was found that in the case of Examples 1 to 4, the level of the resistance change rate was 10% to 18% while in the case of Comparative Examples 1 to 4, the resistance change rate was relatively high, e.g., 25% to 30%.

Meanwhile, in the case of Comparative Example 1, the coverage of the adhesive layer was 50%, and the level of the wet adhesive strength was increased to 23 gf/20 mm. However, this layer itself acted as a resistor, and as a result, the resistance change rate was increased to about 30%.

In the case of Comparative Example 2, PVDF-CTFE was used for the coating layer, instead of the hybrid polymer binder. In this case, when a load was applied at high temperatures, due to a low thermal deformation temperature of CTFE, CTFE is partially dissolved in the electrolyte, leading to an increase of ions in the electrolyte. As a result, it can be found that the resistance change rate was increased to about 27.8%.

In the case of Comparative Example 3, the acrylamide-based binder was used for the coating layer instead of the hybrid polymer. In this case, the solubility in the electrolyte was high, and the ionic conductivity of the electrolyte was degraded. As a result, it can be found that the level of the resistance change rate was increased to 25%.

In the case of Comparative Example 4, the same binder as the hybrid polymer binder used for the coating layer was used for the adhesive layer instead of the acrylic polymer. It can be found that the electrolyte solubility of PVDF-HFP was increased compared to that of the acrylic binder in the high-temperature electrolyte, and as a result, the level of the resistance change rate was increased to 28%.

Therefore, the electrochemical device separator according to one embodiment of the present disclosure and the electrochemical device including the same include the hybrid polymer binder in the coating layer, and the coverage of the adhesive layer is adjusted, thereby maintaining the adhesive strength and reducing the resistance increase rate.

While the embodiments of the present disclosure have been described, it will be appreciated by one of ordinary skill or knowledge in the art that the embodiments of the present disclosure may be changed or modified in various ways within the scope that does not depart from the technical scope of the various embodiments of the present disclosure defined in the claims attached herein below.

### DESCRIPTION OF SYMBOLS

100: Separator for electrochemical device
110: Porous polymer substrate
130: Coating layer
150: Adhesive layer

What is claimed is:

1. A separator for an electrochemical device, comprising:
a porous polymer substrate;
a coating layer provided on at least one surface of the porous polymer substrate, and including a first acrylic polymer binder, a hybrid polymer binder, and inorganic particles; and
an adhesive layer including a second acrylic polymer binder, on the coating layer,
wherein the adhesive layer forms a pattern having a predetermined coverage on the coating layer.

2. The separator for an electrochemical device according to claim 1, wherein the thickness of the porous polymer substrate is 8 μm to 15 μm.

3. The separator for an electrochemical device according to claim 1, wherein the thickness of the coating layer is 1 μm to 3 μm.

4. The separator for an electrochemical device according to claim 1, wherein the content of the first acrylic polymer binder is 1 part by weight to 10 parts by weight relative to 100 parts by weight of the coating layer.

5. The separator for an electrochemical device according to claim 1, wherein the content of the hybrid polymer binder is 1 part by weight to 10 parts by weight relative to 100 parts by weight of the coating layer.

6. The separator for an electrochemical device according to claim 1, wherein the hybrid polymer binder includes a fluorinated copolymer and an acrylic copolymer.

7. The separator for an electrochemical device according to claim 6, wherein the fluorinated copolymer is a copolymer of polyvinylidene fluoride (PVDF) and hexafluoropropylene (HFP).

8. The separator for an electrochemical device according to claim 7, wherein the content of the hexafluoropropylene (HFP) is 5 wt % to 20 wt % relative to 100 wt % of the fluorinated copolymer.

9. The separator for an electrochemical device according to claim 1, wherein the content of the second acrylic polymer binder is 80 parts by weight to 95 parts by weight relative to 100 parts by weight of the adhesive layer.

10. The separator for an electrochemical device according to claim 1, wherein the adhesive layer forming the pattern on the coating layer is distributed with a coverage corresponding to greater than 0% and less than or equal to 30% of the surface area of the coating layer.

11. The separator for an electrochemical device according to claim 1, wherein the thickness of the adhesive layer is 0.2 μm to 1 μm.

12. The separator for an electrochemical device according to claim 1, wherein the resistance change rate of the separator is 20% or less.

13. The separator for an electrochemical device according to claim 1, wherein the wet adhesive strength of the separator is 8 gf/20 mm to 20 gf/20 mm.

14. An electrochemical device comprising:
a positive electrode;
a negative electrode; and
the separator for the electrochemical device according to claim 1, the separator being located between the positive electrode and the negative electrode.
